(19) United States
(12) Patent Application Publication
(10) Pub. No.: US 2026/0338335 A1
(43) Pub. Date: Oct. 29, 2026

(54) LIGHTING DEVICE FOR USE WITH LED STRIPS

(71) Applicant: IGUZZINI ILLUMINAZIONE S.P.A., Recanati (IT)

(72) Inventor: Massimo GATTARI, Potenza Picena (IT)

(21) Appl. No.: 19/486,237

(22) PCT Filed: May 24, 2024
(86) PCT No.: PCT/IB2024/055059

§ 371 Date: Nov. 20, 2025

(30) Foreign Application Priority Data
May 26, 2023 (IT) 102023000010704

(51) Int. Cl. F21S 4/24; F21Y 103/10; F21Y 115/10

(52) U.S. Cl. CPC F21S 4/24; F21Y 2103/10; F21Y 2115/10

(57) ABSTRACT

A LED light strip for floor installation comprising an elongated body, in turn comprising an inner compartment adapted to house a support for LED light sources, a transparent cover element fixed to the upper part of said elongated body and an assembly and positioning rail.

### FIELD OF THE INVENTION

The present invention relates to the field of lighting devices comprising LED lighting sources (Light Emitting Diodes). In particular, the present invention relates to the field of architectural lighting devices comprising LED strips.

### BACKGROUND ART

So-called LED strips are lighting devices comprising approximately tubular sheaths made of flexible material, for example made of silicone plastic material or polyurethane resin, inside which a plurality of LEDs is housed.

Said LEDs are usually mounted on a printed circuit, which is also flexible, together with possible configuration circuits, and they are further connected to a power supply cable which is usually accessible at one end of the strip and connectable to outer power supply means, conventionally made with power supplies providing output voltages of 12, 24 V or 48 VDC.

The LEDs in the strip may be of a single color or of different colors or of an iridescent color within a certain range of colors. The mechanical and electrical structure of these LED strips may make them adapted to be cut to the length desired by the user without compromising the operation thereof and this allows for a high flexibility when choosing the length in which said LED strips are made and industrially produced.

In general, the material from which the strip is made is translucent, at least in the front part, and it is such as to allow the light emission of said LEDs to pass through. Furthermore, said LED strips are generally provided with wall fixing means, comprising holes or slots adapted to receive anchoring screws or the like, or a layer of adhesive applied to the face of the strip opposite to the one of the light emissions.

The availability of high-intensity LED lighting sources, as well as the simplicity and flexibility of use, have quickly made LED strips very popular and used in a large number of applications.

A drawback of the LED strips of the prior art, however, is linked to the difficulty of using them on the floor, especially outdoor floors. The first issue consists of the maximum bearable mechanical stress which often prevents the installation of light strips, for example, in floors, walkways, paths leading to homes or garages, public pedestrian areas, etc. In all these cases, in fact, the lighting device must have sealing and robustness features which allow floor installation.

The LED strips adapted to be used for the above applications are therefore made in ways which often lead to the detriment of performance and light efficiency.

For example, to make the front part of the LED light strip, resins are used which have a limited surface hardness and do not allow a light extraction comparable to that which would be achieved, for example, by using glass.

Furthermore, these resins are subject, due to aging, to a change in the transparency and color features thereof and this obviously affects the features of the light emission which tends to deteriorate over time.

The need is therefore apparent for a LED light strip which is capable of solving the technical issues described above.

It is therefore the object of the present invention introducing a lighting device containing a LED light strip for installation on the floor or on walls, both outside and inside buildings, adapted to allow the maximum extraction of light possible from the LEDs therein, and provided with a robust structure simple to assemble, such that it may be easily installed in any context.

It is another object of the present invention introducing a lighting device containing a LED light strip for installation on the floor both outside and inside buildings, comprising a structure adapted to maintain the correct operation even in the event of mechanical stress and significant temperature changes and to protect the inner LED light strip.

### BRIEF DESCRIPTION OF THE INVENTION

This brief description relates to a lighting device comprising an assembly rail, which may be of the modular type to maximize assembly flexibility in the various installation conditions, an elongated body, preferably made of plastic material, adapted to contain a LED light strip and to allow the extraction of the light emission, and a glass covering element adapted to cover and seal said elongated body inside the assembly rail.

Said elongated body preferably comprises an inner compartment adapted to house a LED light strip made from a printed circuit on which the LED sources are mounted. In a preferred embodiment, the inner compartment takes up less space and is adapted to house the LED light strip oriented so that the assembly surface of the LEDs faces laterally. In another preferred embodiment, the inner compartment takes up more space and is adapted to house the LED light strip oriented so that the assembly surface of the LEDs faces upwards, towards the glass cover.

Furthermore, the elongated body preferably consists of two parts which may be made by means of a co-extrusion process. A lower part which delimits the aforesaid inner compartment and the lateral sides of the elongated body, made of a material which is usually white, or of light color to reflect incident light rays. A diffusing upper part, generally opaline.

Both parts, which may, as mentioned, be co-extruded, are preferably made of high transmissivity silicone polymer material to allow the maximum extraction of the light emitted by the underlying LED sources.

In one embodiment, the assembly rail is preferably made in three distinct parts adapted to be assembled: a base and two side walls. The base is preferably made with a rigid metal strip provided with a plurality of holes at the lateral edges.

The lateral walls are also made of metal strips having an edge provided with a plurality of protrusions adapted to engage with the holes of the base. The metal strips of the lateral walls are also provided with protrusions which, when the assembly rail is assembled, face towards the inside of the rail and provide the required support to the lateral sides of the aforesaid elongated body.

Alternatively, the aforesaid assembly rail may be made by means of a single metal bar having a U-section, the lateral walls of which are also provided with protrusions supporting the lateral sides of the aforesaid elongated body.

The glass covering element is arranged on the top of the upper part of the aforesaid elongated body and fixed by means of a bonding made, for example, with a liquid silicone paste, which ensures adhesion and excellent light transmissivity.

### BRIEF DESCRIPTION OF THE DRAWINGS

Further objects, features and advantages of the present invention will be more apparent from the following detailed description provided by way of non-limiting example and illustrated in the accompanying figures, in which:

FIG. 1 shows a first preferred embodiment of the device according to the present description;

FIG. 2 shows a second preferred embodiment of the device according to the present description;

FIG. 3 shows a third preferred embodiment of the device according to the present description; and

FIG. 4 shows a fourth preferred embodiment of the device according to the present description.

The following description of exemplary embodiments relates to the accompanying drawings. The same reference numerals in various drawings identify the same elements or similar elements. The following detailed description does not limit the invention. The scope of the invention is defined by the accompanying claims.

### DETAILED DESCRIPTION OF THE INVENTION

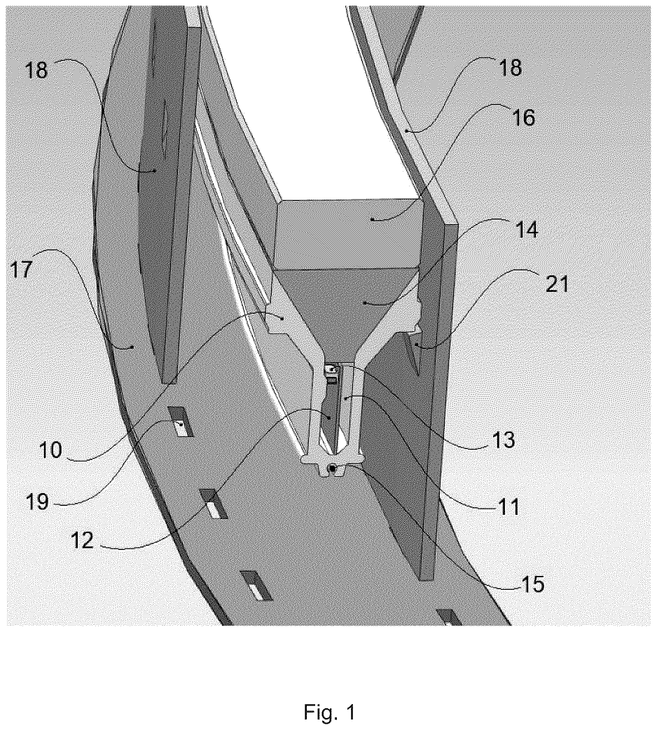

With reference to the accompanying FIG. 1, a first preferred embodiment of the object of the present description relates to a lighting device comprising an assembly rail and an elongated body 10 in turn comprising an inner compartment 11 adapted to house a LED light strip comprising a plurality of LEDs 13 mounted on a support, for example a printed circuit 12 of the flexible type.

Said elongated body 10 comprises, in turn, two parts which may be made by means of a co-extrusion process. A lower part which delimits the aforesaid inner compartment 11 and the lateral sides of the elongated body 10, preferably made of a material which is white or light in color to reflect incident light rays. A diffusing upper part 14, generally opaline, and adapted to transmit the light emitted by said LEDs 13.

Furthermore, in one embodiment, said elongated body 10 may comprise at least one flexible element, integral with said elongated body 10 and arranged along the entire length of said elongated body 10, at the printed circuit of the light strip on which the LEDs 13 are mounted.

Said at least one flexible element is preferably made with a wire 15 made of steel or similar material, which offers high flexibility and robustness features, together with the possibility of being made with even very small diameters.

Preferably, said flexible element is arranged inside said elongated body 10 and integrally constrained thereto. In the event that the elongated body 10 is made by extrusion, said flexible element may be, for example, inserted inside said elongated body 10 during the extrusion process of the latter, or subsequently inserted inside a special cavity obtained inside said elongated body 10 and then suitably glued so as to constrain it integrally and irreversibly to said elongated body 10.

The presence of said flexible element placed inside said elongated body 10, at the LED light strip, ensures that the neutral axis of the sheath is constrained approximately at the printed circuit 12 of the LED light strip so as to avoid traction or compression stresses on the printed circuit itself due to the bends and twists undergone by the LED light strip.

Substantially, the presence of said flexible element rigidly integral with said elongated body 10 will ensure that said elongated body 10, the LED light strip and the related printed circuit 12 always follow corresponding curvatures such that said elongated body 10 may not exert unwanted stresses on the LED strip and on said printed circuit 12 by virtue of different curvatures and tractions undergone, with respect to the curvatures and tractions undergone by the LED strip and the printed circuit 12.

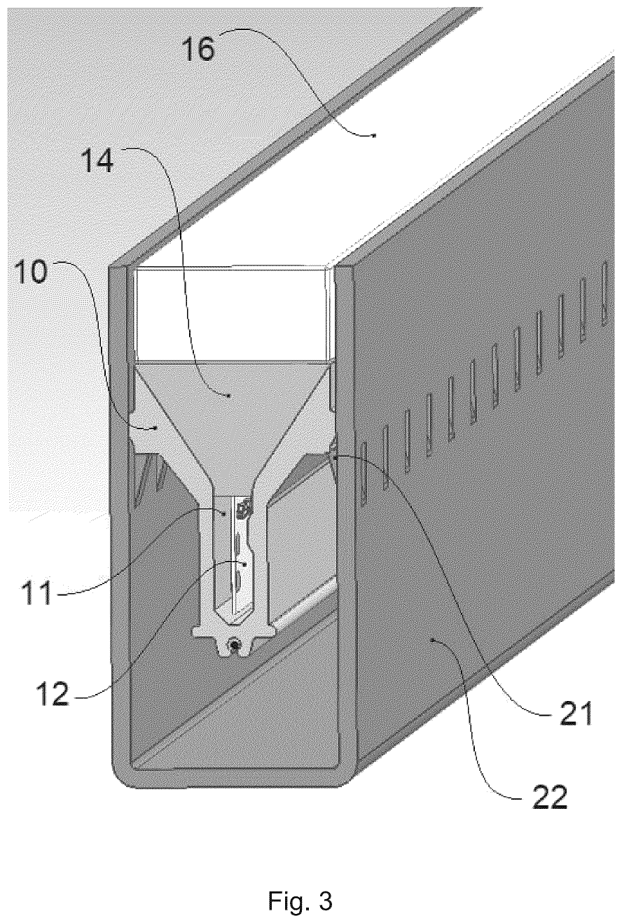

In the preferred embodiment shown in the accompanying FIGS. 1 and 3, said elongated body 10 has a section which is tapered towards the bottom comprising an inner compartment 11 adapted to house the LED strip. The upper part 14 of said elongated body 10, adapted to emit the light radiation of the LEDs 13, has, however, a quasi-triangular section which extends from said inner compartment with an angle wide enough to ensure the desired quantity of light emission. In this case, said flexible element is preferably made by means of a single wire 15 made of steel, arranged at the bottom of said elongated body 10 and aligned with the printed circuit 12 of the LED strip.

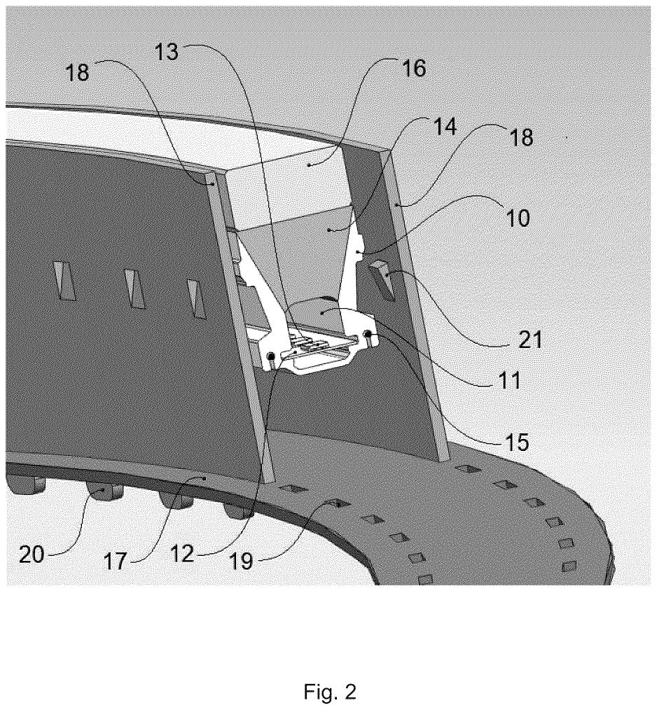

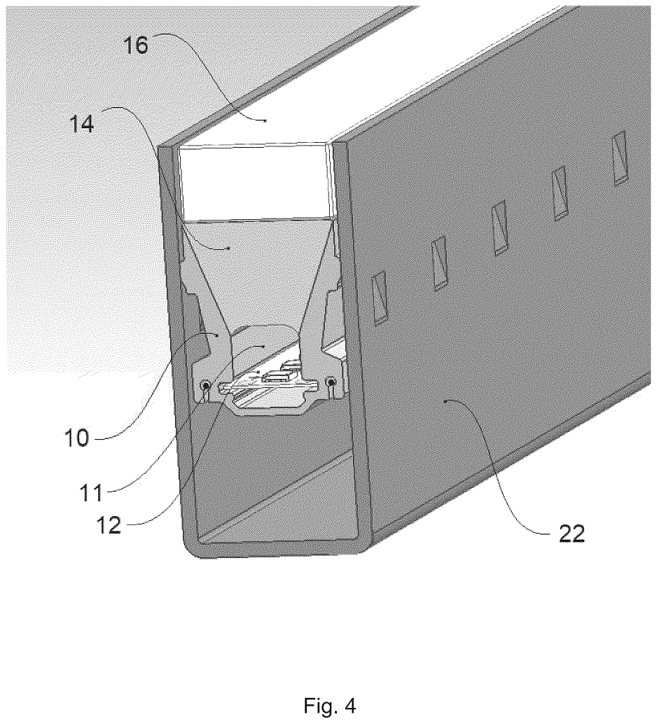

The preferred embodiment shown in the accompanying FIGS. 2 and 4, however, comprises an elongated body 10 having a section with an almost rectangular or trapezoidal shape, the lower part of which, also in this case, comprises an inner compartment 11 adapted to house the LED strip. Advantageously, two grooves 20 are present on the walls of said inner compartment, adapted to house the ends of the printed circuit 12 of the LED strip. The upper part of said elongated body 10, adapted to emit the light radiation of the LEDs 13, has, however, a trapezoidal section which extends from said inner compartment with an angle wide enough to ensure the desired quantity of light emission. In this case, said at least one flexible element is preferably made by means of a pair of rigid steel wires 15, arranged inside said elongated body 10, arranged at the sides of the printed circuit 12 of the LED strip and aligned therewith. In both preferred embodiments described, the two parts, upper and lower, of said elongated body 10, may be made of silicone polymeric material. The upper part 14 may advantageously be made of a high transmissivity silicone polymer material, opaline or transparent, to allow the maximum extraction of the light emitted by the light sources of the underlying LED strip.

The two parts, upper 14 and lower, of said elongated body 10 may be made by means of a co-extrusion process.

Furthermore, a transparent cover element 16, preferably made of tempered glass, is arranged on the upper part of the aforesaid elongated body 10 and fixed by means of a bonding made, for example, with a silicone paste or with a similar substance, which ensures adhesion and excellent light transmissivity. Other adhesives or fixing means may be used, provided with the required adhesion and light transmissivity features.

The tempered glass cover ensures to the lighting device according to the present description the required seal and robustness to allow the installation thereof on the floor.

Furthermore, the device according to the present description comprises an assembly and positioning rail provided with means for supporting the elongated body 10. This assembly and positioning rail may be made in three parts adapted to be assembled: a base 17 and two lateral walls 18. Said rail is preferably made of a metal material such as aluminum, brass, stainless steel, etc.

The base 17 of said assembly rail is preferably made with a rigid metal strip provided with a plurality of holes 19 at the lateral edges.

The lateral walls are also made of metal strips having an edge provided with a plurality of protrusions 20 adapted to engage with the holes of the base. Furthermore, the metal strips of the lateral walls are preferably provided with means for supporting the elongated body 10. These support means may be made from protrusions 21 which, when the assembly rail is assembled, face towards the inside of the rail itself and provide the required support to the lateral sides of the aforesaid elongated body 10, as shown in the accompanying Figures. Said protrusions may be made by means of half-blankings performed on the strips of the lateral walls 18, at a predetermined distance from one another.

The preparation of the device according to the present description involves initially assembling the assembly rail by joining said base 17 with two lateral walls 18. The assembled rail is then arranged in the track obtained in the floor or in the wall where the installation is provided. With this configuration, said rail may be made both curved and straight.

Alternatively, the aforesaid assembly rail may be made by means of a single metal bar having a U-section 22, the lateral walls of which are also provided with protrusions 21 supporting the lateral sides of the aforesaid elongated body 10.

The aforesaid rail may be arranged in a track obtained in a floor or wall, or resting on a plane leveled to the desired height. For example, for a floor arrangement, the rail is arranged at a height such as to position the lighting device flush with the floor. It is therefore necessary to predict the filling thickness of the track, of the tiles or of the floor tiles and of the adhesives used for the fixing thereof.

The steps to follow for a correct installation may be the following:
1. Positioning the rail on the installation plane, for example inside a track obtained in a floor;
2. Blocking the rail with cement or other adhesive and hardening pastes or by means of mechanical systems;
3. Installing the ducts for electrical supply cables;
4. Inserting the infill to prepare the concrete “cast” (the infill is adapted to close the mouth of the rail and prevent the concrete from flooding it);
5. Filling the parts adjacent to the rail with concrete, leveling until the space required for the finishing part is covered;
6. Finishing, so as to level the floor covering with the rail of the lighting device, for example using adhesive glues and tiles;
7. Passing the electrical supply cables;
8. Inserting the elongated body and connecting to the electrical supply cables.

The lighting device to be used with LED strips for floor or wall installation according to the present description fills the gaps in the prior art by solving the technical issues described above, and also ensuring a correct operativity even in the event of mechanical stresses and significant thermal changes, making it suitable for installations in any context.

1. A lighting device, comprising:
an elongated body comprising
a lower part provided with an inner compartment adapted to house a LED strip comprising a plurality of LEDs mounted on a support,
an upper part adapted to diffuse the light emitted by the LEDs of said LED strip, the lower part and the upper part being made by means of a co-extrusion process, and
a transparent cover element having the same width of said upper part,
and fixed to the top of said upper part by means of an adhesive capable of transmitting light;
an assembly rail comprising a base and two lateral walls, the assembly rail adapted to contain and protect said elongated body to allow the installation thereof in special tracks obtained in floors or walls, wherein the lateral walls of the assembly rail are provided with support means facing towards the inside of the assembly rail, adapted to provide support to the lateral sides of the elongated body.

2. The lighting device to of claim 1, characterized in that said transparent cover element is made of tempered glass.

3. The lighting device of claim 1, characterized in that it comprises at least one flexible element arranged inside said elongated body and integral therewith, in a juxtaposed position with respect to said support for LED light sources.

4. The lighting device of claim 1, characterized in that the upper part of said elongated body is made of high transmissivity silicone plastic material, to allow maximum extraction of the light emitted by the LEDs of said LED strip.

5. The lighting device of claim 1, characterized in that said support for LED light sources comprises at least one printed circuit.

6. The lighting device of claim 5, characterized in that said inner compartment comprises means for the engagement with said at least one printed circuit.

7. The lighting device of claim 6, characterized in that said means for the engagement with said at least one printed circuit comprise two grooves adapted to house the edges of said printed circuit.

8. The lighting device of claim 3, characterized in that said at least one flexible element comprises at least one steel wire.

9. The lighting device of claim 3, characterized in that said at least one flexible element is adapted to be inserted inside a special cavity obtained inside said elongated body and to be glued to said elongated body.

10. The lighting device of claim 1, characterized in that said elongated body is made with an extruded silicone plastic material.

11. The device of claim 1, characterized in that said assembly rail is made by means of a single metal bar having a U-section.

12. The device of claim 1, characterized in that said assembly rail comprises three parts adapted to be assembled: a base and two lateral walls.

13. The device of claim 12, characterized in that said base is made with a metal strip provided with a plurality of holes at the lateral edges, and said lateral walls are also made from metal strips having an edge provided with a plurality of protrusions adapted to engage with the holes of the base.

14. The lighting device claim 1, characterized in that said support means facing towards the inside of the assembly rail, adapted to provide support to the lateral sides of the elongated body comprise a plurality of protrusions.

15. The lighting device of claim 14, characterized in that said protrusions are made by means of half-blankings performed on the lateral walls of the assembly rail, at a predetermined distance from one another.
